(19) United States
(12) Patent Application Publication
(10) Pub. No.: US 2011/0285149 A1
(43) Pub. Date: Nov. 24, 2011

(54) Multiple access door lock mechanism with reversible cam actuation

(75) Inventor: Alan K. Uyeda, Irvine, CA (US)

(73) Assignee: ADAMS RITE MANUFACTURING CO.

(21) Appl. No.: 12/800,775

(22) Filed: May 24, 2010

(51) Int. Cl. E05B 3/00; E05B 15/02

(52) U.S. Cl. 292/336.3; 292/341.15

(57) ABSTRACT

In combination a door, latch structure at an edge of the door, and independently opens the door latch operating components at opposite sides of the door, displaceable structure in the door having a position blocking movement of the latch structure, first means responsive to displacement of a selected one of the components for displacing the structure from the blocking position to allow movement of the latch structure, for door opening, and the first means including a rotatable cam having reversible positions in each of which motion is transmitted to the displacement structure in response to displacement of the respective components.

### BACKGROUND OF THE INVENTION

This invention relates generally to ease and reliability of door unlocking mechanisms and more particularly to reliability of access to door unlocking, as from both outside and inside locations, and with use of door handles that rotate in opposite directions to actuate latches.

There is continued need for the above referred to mechanisms, integrated in easily hand operated apparatus, installed in a door, and to allow door handle rotation in either clockwise or counterclockwise direction as determined upon lock installation in a door. There is also need for the simple, reliable, compact combination of elements, functioning as described and producing the improved results as will appear.

### SUMMARY OF THE INVENTION

It is a major object of the invention to provide, in combination:

a) a door, latch mechanism at an edge of the door, and door latch operating components at opposite sides of the door,

b) displaceable structure in the door having a position blocking movement of the latch mechanism,

c) first means responsive to displacement of either of the components for displacing the structure from blocking position to allow movement of the latch mechanism for door opening, and

d) said first means including a rotatable cam having reversible positions in each of which motion is transmitted to the displaceable structure in response to displacement of the respective components.

As will be seen, the structure typically includes a slider displaceable in response to operation of said first means, in either of the cam reversible positions, and as the cam is rotated.

As will be seen, the slider is typically movable in response to turning of either of said components to displace the slider, allowing pivoting movement of the latch means, and as the cam is rotated.

Further, the reversible cam allows installation of the lock mechanism to accommodate turning of a door handle clockwise or counterclockwise to open a door, this being referred to as “left handed” or “right handed” operation of a door handle. As will be seen, a spring may be provided to bodily urge the cam in the direction of an axis of cam pivoting, to accommodate cam position reversal, upon installation.

An additional object is to provide a cam that defines a through slot extending between opposite cam sides, the cam having a pivot spaced from the slot, there being a cam actuating pin extending in the slot in each of said reversible cam positions. Typically, the pin is carried by one of the components, in offset relation to an axis of rotation defined by the cam pivot.

Yet another object is to provide for the reversible cam installation and operation, in a lock wherein the slider, as referred to, is operated or displaced either in response to cam selection rotation as referred, or in response to an electrically actuated device, including a solenoid.

A further object is to provide an axis of cam pivoting extending generally normal to the plane of the cam, the cam having a through slot spaced from that axis, there being a cam pivot actuating pin extending in the slot to controllably rotate the cam in response to door handle turning, in each of the reversible positions of the cam. A cam mounting allows bodily axial cam replacement, or release to be reversed in position, and a spring is oriented to resist such bodily axial cam displacement and to yieldably return the cam to operating position in each of such reversible positions.

These and other objects and advantages of the invention, as well as the details of an illustrative embodiment, will be more fully understood from the following specification and drawings, in which:

### DRAWING DESCRIPTION

FIG. 1a is an elevation showing a door, door handle, and lock mechanism in the door;

FIG. 1b is an elevation showing the opposite side of the FIG. 1a door, and a handle and the lock mechanism;

FIG. 2 is an enlarged section taken in elevation through a portion of the lock mechanism; and in relation to a bolt, a reversible cam being shown for counterclockwise rotation;

FIG. 3 is an enlarged elevation, taken edgewise of the cam, and showing cam mounting enabling reversal of the cam;

FIG. 4 is a view like FIG. 3, but showing cam removal, as during its reversing;

FIG. 5 is a view like FIG. 2 but with the cam mounted in reversed position, to be clockwise rotatable;

FIG. 6 is a view of the cam, showing details of construction; and

FIG. 7 is an axially exploded perspective view of the preferred cam and associated mechanisms.

### DETAILED DESCRIPTION

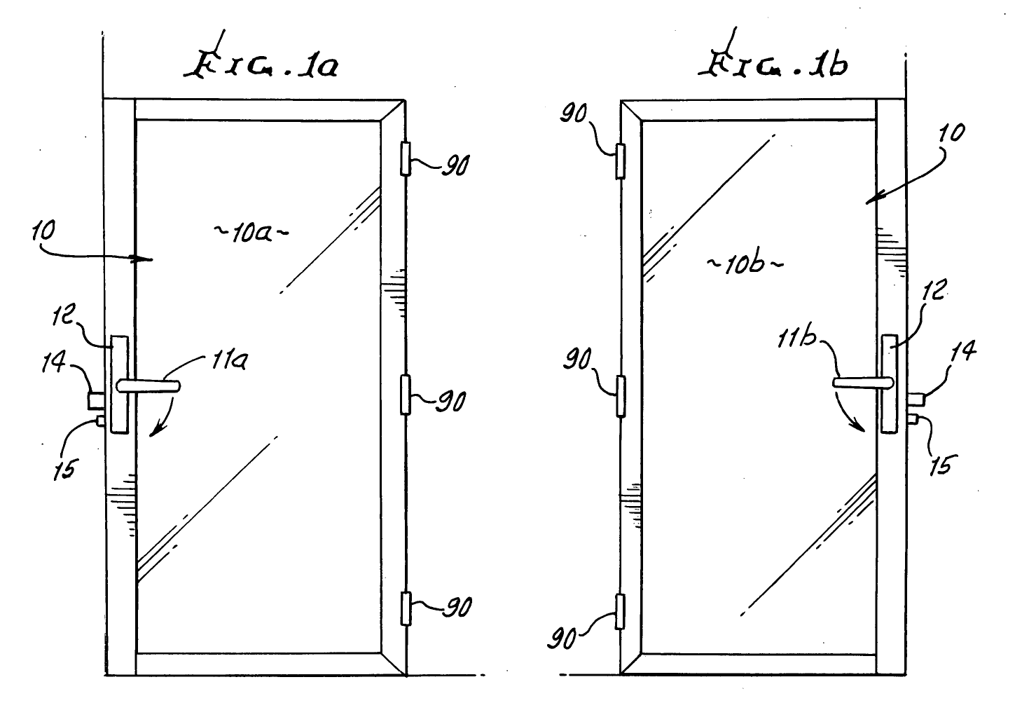

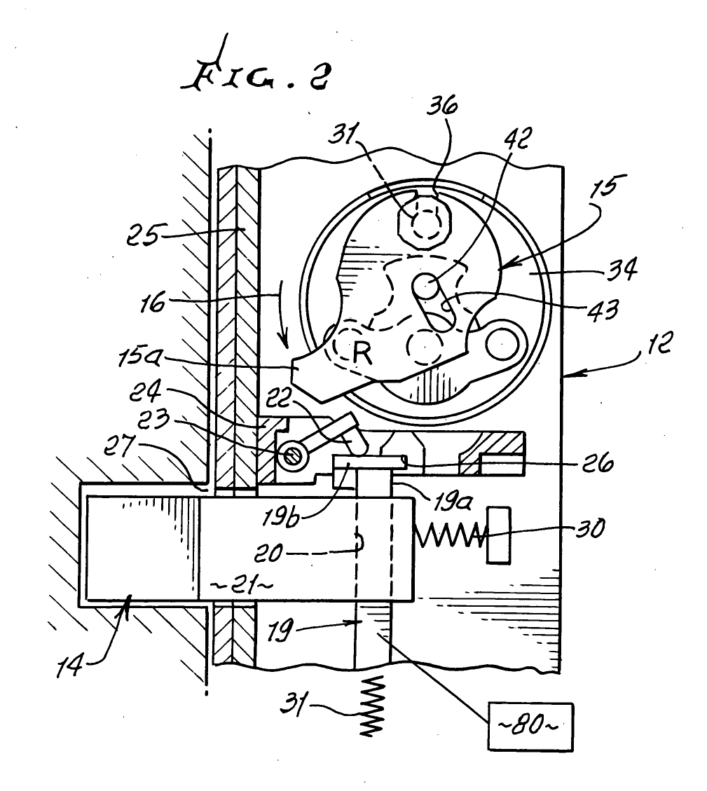

Referring first to FIGS. 1a and 1b, door 10 has opposite sides 10a and 10b, handles 11a and 11b at said respective sides, and a lock mechanism 12 located in the door. Latch structure protrudes form the door edge 13, and may include one or more latches. Two such latches are shown, a main latch 14 and an auxiliary latch 15. Handles 11a and 11b may comprise one form of door operating components. Door pivots or hinges appear at 90.

Extending the description to FIG. 2, displaceable structure is provided in the door, i.e. within the lock mechanism 12 in the door, and has one position blocking movement, i.e. retraction, of the latch structure, typically main latch or bolt 14.

First means is provided to be responsive to displacement of a selected one of the door operating components for displacing the displaceable structure from blocking position, to allow movement of the latch structure, for door opening. Such first means typically includes a rotatable cam 15 having reversible positions (see FIGS. 2 and 5), in each of which motion is transmitted to the displaceable structure in response to displacement of the respective components (for example handles 11a and 11b). In the example, as a handle is rotated counterclockwise, the cam is rotated counterclockwise in FIG. 2 (see arrow 16), and as a handle is rotated clockwise, the reverse positioned cam is rotated clockwise in FIG. 5 (see arrow 17). Rotation of the cam in FIG. 2 may correspond to right handed rotation of a handle (see latch “R” on the side of the cam), and rotation of the cam in FIG. 5 may correspond to left handed rotation of a handle (see latch “L” on the opposite side of the cam).

The displaceable structure may advantageously comprise a slider 19 having the form of a longitudinally downwardly elongated shaft 19a, and a head 19b on the shaft to be displaced bodily downwardly in a bore 20 formed in bolt carrier 21. An angled dog 22, pivoted at 23, presses downwardly on head 19b as the cam 15 and extension 15a are rotated to engage and displace the dog downwardly in FIGS. 2 and 5. The pivot 23 is carried by structure 24 attached to lock frame 25.

As the head 19b is displaced downwardly, it releases from pocket 26 in structure 24, to allow the latch bolt to be retracted to the right in response to bolt angled face engagement with wall opening 27, as the door is pushed and swung into open position. When the door is returned to closed position, spring 30 urges the carrier 21 to the left, returning the bolt to the position shown in FIGS. 2 and 5. Also, a spring 31 urges the shaft 19a upwardly, returning head 19b upwardly into pocket 26, locking the bolt in FIGS. 2 and 5 position.

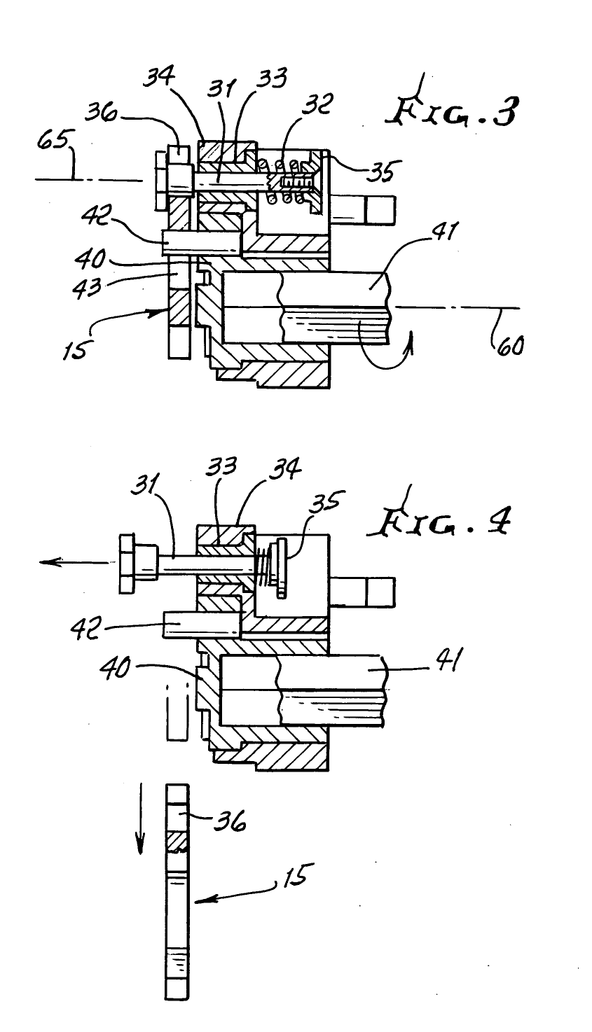

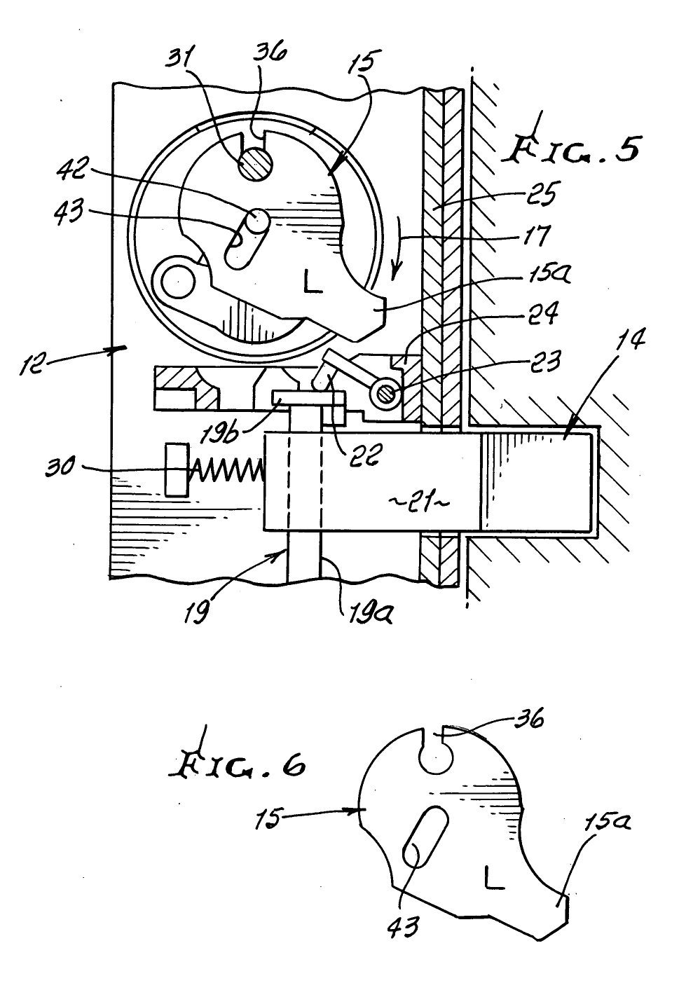

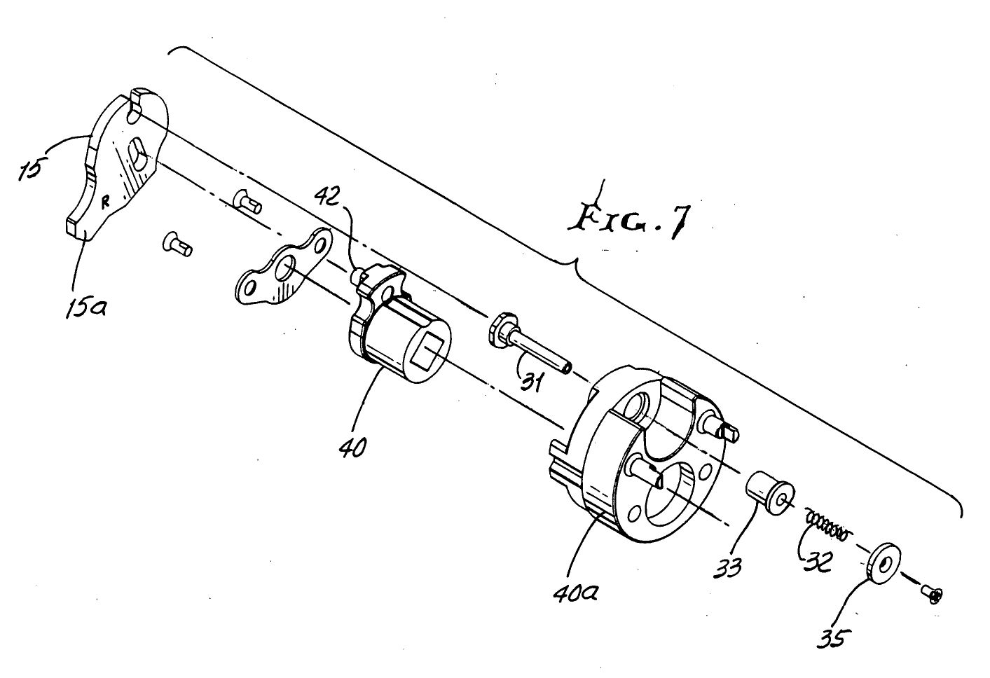

Referring to FIGS. 3 and 4, they illustrate reversing of the cam position as between FIGS. 2 and 5. The cam 15 is carried on a pin 31 urged by spring 32 to the right, in FIG. 3. Pin 31 is slidable in a tubular bushing 33 carried by structure 34. A cap 35 on the pin compresses the spring as the cam is manually pulled to the left, for release and reversing of its position, as appears in FIG. 4. A slot 36 in the upper extent of the cam enables cam downward release from the pin, for reversing.

A cam driver 40 is carried on handle shaft 41 to rotate the cam as the handle is turned. A pin 42 carried by the driver is received in a slot 43 in the cam, the slot angled to rotate the cam about pivot axis 65, that extends normal to the plane of the cam as the driver is turned. The pin is carried in offset relation to the axis 60 of rotation defined by the shaft.

Latch or bolt 15 is below the latch 14, and operates in similar manner as latch 14, but is unblocked against retraction. The two latches are mounted to be bodily retracted, and have angled actuating surfaces facing in opposite directions to bear against wall surfaces.

FIG. 2 also schematically shows electrically operable actuating means 80 for effecting displacement of the displaceable structure, including slider 19 from blocking position and allow movement of the latches, for door opening.

I claim:

1. In combination:
a) a door, latch structure at an edge of the door, and independently operable door latch operating components at opposite sides of the door,
b) displaceable structure in the door having a position blocking movement of the latch structure,
c) first means responsive to displacement of a selected one of the components for displacing said structure from said blocking position to allow movement of the latch structure, for door opening, and
d) said first means including a rotatable cam having reversible positions in each of which motion is transmitted to said displacement structure in response to displacement of the respective components.

2. The combination of claim 1 including electrically operable actuating means for effecting displacement of said structure from said blocking position to allow movement of the latches, for door opening.

3. The combination of claim 1 wherein said structure includes a slider displaceable in response to operation of said first means, in either of the cam reversible positions, and as the cam is rotated.

4. The combination of claim 1 wherein said first means includes a slider movable in response to turning of either of said components to displace the slider, allowing pivoting movement of the latch means, and as the cam is rotated.

5. The combination of claim 1 including a spring yieldably and bodily urging the cam in the direction of an axis of cam pivoting.

6. The combination of claim 4 including a door frame carrying said structure, said first means, said cam and said actuating means.

7. The combination of claim 1 including a frame carrying said structure, said first means and said actuating means.

8. The combination of claim 1 wherein said two latches are mounted to be bodily retracted, and have latch actuating surfaces facing in opposite directions.

9. The combination of claim 7 wherein said two latches are mounted, in side-by-side relation to be bodily retracted.

10. The combination of claim 1 wherein the cam defines a through slot extending between opposite cam sides, the cam having a pivot spaced from said slot, there being a cam actuating pin extending in said slot in each of said reversible cam positions.

11. The combination of claim 10 wherein the pin is carried in offset rotation to an axis of rotation defined by said cam pivot.

12. The combination of claim 1 wherein the cam has an axis of pivoting extending generally normal to the plane of the cam, the cam having a through slot spaced from said axis of pivoting, there being a cam pivot actuating pin extending in the slot to controllably rotate the cam in response to door handle turning, in each of the reversible position of the cam.

13. The combination of claim 12 including a cam mounting allowing bodily axial cam displacement, for release to be reversed in position, and there being a spring oriented to resist said bodily axial cam displacement and to yieldably return the cam to cam operating location, in each of said reversible position.
